(19) United States
(12) Patent Application Publication
(10) Pub. No.: US 2005/0238358 A1
(43) Pub. Date: Oct. 27, 2005

(54) Compact optical transceivers

(76) Inventor: Greta Light, San Mateo, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/829,609

(22) Filed: Apr. 22, 2004

(51) Int. Cl. H04B 10/00

(52) U.S. Cl. 398/135

(57) ABSTRACT

A compact optical transceiver module includes a transceiver housing within which is disposed a vertically oriented transceiver substrate to which one or more OSAs are attached. Longitudinal axes of the TOSA and ROSA are positioned above an imaginary horizontal plane bisecting the transceiver housing so that when the compact optical transceiver module is attached to an HBA or other board, the board space directly below the TOSA and ROSA is available for the placement of components. When the compact optical transceiver module is positioned on a host bus adaptor, the resulting assembly is suited for use as an internal network connection in a computerized system such as a desktop, laptop, or handheld computerized system.

### CROSS-REFERENCE TO RELATED APPLICATIONS

Not applicable.

### BACKGROUND OF THE INVENTION

1. The Field of the Invention

This invention relates to systems and methods for integrating fiber optic transceivers into computerized systems.

2. Related Technology

Fiber optic technology is increasingly employed as a vehicle by which information can be reliably transmitted via a communications network. Networks employing fiber optic technology are known as optical communications networks, and are marked by high bandwidth and reliable, high-speed data transmission.

Optical communications networks employ optical transceivers in transmitting information via the network from a transmission node to a reception node. Generally, god such optical transceivers implement both data signal transmission and reception capabilities, such that a transmitter portion of a transceiver converts an incoming electrical data signal into an optical data signal, while a receiver portion of the transceiver converts an incoming optical data signal into an electrical data signal.

More particularly, an optical transceiver at the transmission node receives an electrical data signal from a network device, such as a computer, and converts the electrical data signal to a modulated optical data signal using an optical transmitter such as a laser. The optical data signal can then be transmitted in a fiber optic cable via the optical communications network to a reception node of the network. Upon receipt at the reception node, the optical data signal is fed to another optical transceiver that uses a photodetector, such as a photodiode, to convert the received optical data signal back into an electrical data signal. The electrical data signal is then forwarded to a host device, such as a computer, for processing.

Generally, multiple components are employed to accomplish different aspects of these functions. For example, an optical transceiver can include one or more optical subassemblies (“OSA”) such as a transmit optical subassembly (“TOSA”), and a receive optical subassembly (“ROSA”). Typically, each OSA is created as a separate physical entity, such as a hermetically sealed cylinder that includes one or more optical sending or receiving components, as well as electrical circuitry for handling and converting electrical signals into optical signals, and vice versa. Within the optical transceiver, each OSA generally includes electrical connections to various additional components such as a transceiver substrate, sometimes embodied in the form of a printed circuit board (“PCB”).

The transceiver substrate can include multiple other active circuitry components particularly designed to drive or handle electrical signals sent to or returning from one or more of the electrically-attached OSAs. Accordingly, such a transceiver substrate will usually include a number of electrical transmission lines with the one or more OSAs. Such connections may include “send” and “receive” data transmission lines for each OSA, one or more power transmission lines for each OSA, and one or more diagnostic data transmission lines for each OSA. These transmission lines are connected between the transceiver substrate and the OSA using different types of electrical connectors, examples of which include an electrical flex circuit, a direct mounting connection between conductive metallic pins extending from the OSA and solder points on the PCB, and a plug connection that extends from the PCB physically and electrically interfaces with the OSA.

Manufacturing standards such as the small form factor (“SFF”), small form factor pluggable (“SFP”), and gigabit small form factor (“XFP”) standards have contributed to a relative reduction in the overall size of transceiver modules, notwithstanding the numerous components that must be included within the transceiver modules. Thus, even under more recent manufacturing standards, the internal arrangement of components in typical transceiver modules nonetheless dictates a certain transceiver size that suits the transceiver module for external connections to a computerized system, such as a desktop computer, a laptop computer, or a handheld.

More particularly, an SFF, SFP, or XFP transceiver module may provide an interface between an optical cable and a standard network cable, such as an Ethernet cable, that plugs into a computerized system. Alternatively, the transceiver module may be mounted in a network panel that includes multiple transceiver modules, the panel including an external connection to a computer system.

In any case, the number of components required to be included in the module, and the size of SFF or SFP transceiver modules, makes it difficult to readily integrate a transceiver module into very small spaces, such as within a pluggable card in a laptop computer RJ-45 envelope, or hand held device. More particularly, some conventional optical transceivers include a ROSA and a TOSA mounted to the transceiver substrate that, in turn, is attached to a board such as a host bus adapter (“HBA”) by way of connectors positioned on the transceiver substrate.

Typically, the ROSA and TOSA reside within a housing that defines optical ports configured to receive optical fiber connectors for interfacing with the ROSA and TOSA. Additionally, the housing defines optical port slots configured and arranged such that when an optical fiber connector is inserted into the optical port, a portion of the optical fiber connector remains exposed. By enabling a user to grasp the exposed portion of the optical fiber connector, the optical port slots facilitate ready removal of the optical fiber connector from the optical port while decreasing the likelihood of damage to the optical fiber connector during the removal process.

Many conventional transceiver housings are configured so that the OSAs are spaced relatively closer to the HBA, or other device upon which the transceiver is mounted, and relatively further away from the optical port slots. This orientation is a general standard employed by many optical network device manufacturers when designing optical cables to fit within the fiber optic receptacles. As discussed below, such arrangements of the ROSA and TOSA have proven problematic however.

For example, the relatively close proximity of the ROSA and TOSA to the HBA or other board precludes the placement of components on the HBA in the area beneath the ROSA and TOSA. Thus, board space on the HBA or other component is not employed to maximum advantage, and the component density of the HBA is thereby impaired. In view of the continuing efforts to optimize board space utilization, so as to further advance the functionality associated with a particular component while also maintaining or reducing component size, this is a significant problem.

A variety of approaches might be employed in an attempt to resolve this problem. For example, some usable HBA space might be gained by shortening the length of a conventional transceiver module and, hence, the transceiver substrate. However, a reduction in the size of the transceiver substrate would impair the functionality of the transceiver by reducing the amount of space available for mounting components necessary to drive the OSAs.

Accordingly, what is needed are compact, integrated transceiver modules that can fit within smaller spaces, and can be implemented within compact components such as an HBA, while maintaining compliance with established standards. Additionally, such transceiver modules should be configured so as to contribute to a relative increase in available space on the board to which the transceiver module is mounted.

### BRIEF SUMMARY OF AN EXEMPLARY EMBODIMENT OF THE INVENTION

In general, exemplary embodiments of the present invention relate to compact transceiver modules that can be implemented with components such as host bus adaptors (“HBA”) in smaller physical envelopes than would otherwise be possible under present manufacturing standards. In particular, one exemplary embodiment of a transceiver module combines standard transceiver OSAs with a compact transceiver substrate that can be mounted on an HBA, such as an HBA for use with a desktop computer, a laptop computer, or other systems, such that a relative increase in HBA board space is realized.

In one exemplary implementation, an optical transceiver includes a transceiver housing that has two sides, a top, a bottom, and front and rear faces, at least the front face having right and left sides. The optical transceiver also includes a transceiver substrate disposed within the transceiver housing in a plane substantially perpendicular to the top and bottom of the transceiver housing. The plane of the transceiver substrate is also substantially perpendicular to respective longitudinal axes defined by the ROSA and the TOSA.

The ROSA and TOSA are arranged, relative to each other, such that when the transceiver housing is viewed from the front, the ROSA is proximate the left side of the front face while the TOSA is located proximate the right side of the front face. Further, optical port slots defined by the transceiver housing face downward and are arranged, relative to the ROSA and TOSA, such that the ROSA and TOSA are located relatively further away from the HBA, or other board, than the optical port slots.

In this way, the ROSA and TOSA are able to fit within the same physical envelope as employed by convention optical transceivers while, at the same time, available board space on the HBA is increased as a result of the ROSA and TOSA being located relatively further away from the board surface. These and other aspects of the present invention will become more fully apparent from the following description and appended claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A is a perspective view of one exemplary implementation of an optical transceiver;

FIG. 1B is a front view of one exemplary implementation of an optical transceiver;

FIG. 1C is a perspective view of an exemplary implementation of an optical transceiver positioned on a host bus adaptor;

FIGS. 2A-2B illustrate aspects of one embodiment of the optical transceiver in a desktop computer of the system environment; and

FIG. 2C illustrates aspects of one embodiment of the optical transceiver in a laptop computer system environment.

### DETAILED DESCRIPTION OF EXEMPLARY EMBODIMENTS OF THE INVENTION

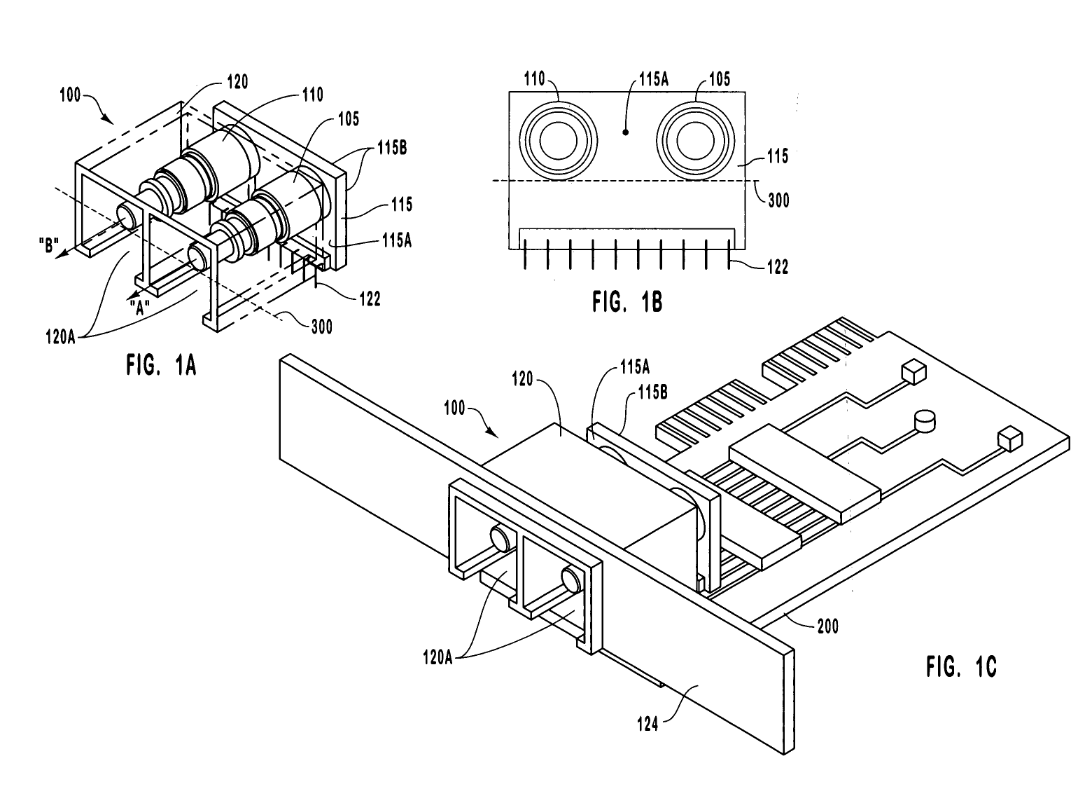

In general, FIGS. 1A-1C illustrate an optical transceiver module 100 that includes a ROSA 105 and TOSA 110 that are mounted on a transceiver substrate 115 residing within a transceiver housing 120. As used herein, an “OSA” refers generally to any one of a transmit optical sub-assembly (“TOSA”) or a receive optical sub-assembly (“ROSA”) that can be mounted to a transceiver substrate for use in a transceiver module. Exemplarily, the transceiver substrate is implemented as a printed circuit board (“PCB”) having electronic components, and electrically conductive elements such as circuit traces, for transmitting power, communication, and other signals between an OSA and other components and systems. It should be noted that although the TOSA 110 and ROSA 105 are shown with roughly similar dimensions in FIGS. 1A through 1C, the illustrated TOSA 110 and ROSA 105 configurations and dimensions are exemplary only and are not intended to limit the scope of the invention in any way.

In addition, although a transceiver substrate 115 can include any circuitry for driving a given OSA, exemplary implementations of the transceiver substrate 115 include components such as a laser driver, memory components, components for driving bias currents and for amplifying signals, for example. As well, the transceiver substrate 115 may be referred to herein as including two surfaces for attachment of Band/or mounting of, OSAs and various other components. Specifically, such surfaces include a front surface 115A and rear surface 115B. The transceiver substrate 115 further includes a plurality of electrical pins 122 oriented so as to be received in a corresponding receptacle, or receptacles (not shown), of the HBA 200 or other board when the transceiver substrate 115 is mounted to the board.

Continuing, as shown in FIGS. 1A-1C, the housing 120 defines downward oriented optical port slots 120A configured and arranged to receive, and facilitate retention of, optical fiber connectors used for optical communication with the ROSA 105 and TOSA 110. As such, when the optical transceiver module 100 is operably positioned and retained on the HBA 200, the optical port slots 120 face downward and the OSAs are, accordingly, positioned relatively far away from the HBA 200, relative to the position of the optical port slots 120A with respect to the HBA 200.

As suggested in the Figures, this arrangement is further advanced by the use of a transceiver substrate 115 that is configured and arranged to be substantially perpendicular with respect to the HBA 200 and the axes “A” and “B” defined, respectively, by the TOSA 110 and ROSA 105. The perpendicular orientation of the transceiver substrate 115 corresponds with a relative reduction in HBA 200 board space consumed by the optical transceiver module 100. Further, as noted above, the ROSA 105 is positioned to the right of the TOSA 110 with the optical port slots 120A facing downward, in contrast with the arrangement employed by conventional optical transceivers where a TOSA is positioned to the left of a ROSA when the optical port slots 120A face downward.

This arrangement of the ROSA 105 and TOSA 110, relative to the HBA 200 surface, in combination with the use of the vertically oriented transceiver substrate 115, thus corresponds to a relative increase in usable HBA 200 board space. Moreover, exemplary implementations of the present invention thus implement a 180° rotation in the orientation of conventional transceiver housings. Furthermore, positioning the ROSA 110 and TOSA 105 on respective left and right sides with the optical port slots 120A facing downward allows exemplary implementations of the present invention to take advantage of existing manufacturing standards for other optical devices, such as existing cable connector configurations.

With respect to the mounting of the ROSA 110 and TOSA 105 to a vertically oriented transceiver substrate 115, and related considerations, the arrangement of components on the front and rear surfaces of a perpendicular transceiver substrate is indicated in greater detail in U.S. patent application Ser. No. ______, filed on ______, entitled OPTICAL TRANSCEIVER WITH INTEGRATED FEEDBACK DEVICE (Workman Nydegger Docket No. 15436.372.1), and U.S. patent application Ser. No. ______ , entitled COMPACT OPTICAL TRANSCEIVERS FOR HOST BUS ADAPTERS (Workman Nydegger Docket No. 15436.373.1), which have been filed on the same day as the present application, and are incorporated herein by reference in their respective entireties.

As suggested earlier herein, FIG. 1B illustrates further advantages that can be realized by rotating, relative to conventional transceivers, the transceiver housing 120, as well as the TOSA 105, and ROSA 110 positions on the transceiver substrate 115. In particular, exemplary implementations of the optical transceiver module 100 are configured so that the optical port slots 120A are oriented downward, and the ROSA 110 and TOSA 105 are thus positioned above an imaginary plane 300 passing through the transceiver substrate 115 at or near the midpoint of the transceiver substrate 115.

Thus, in at least some exemplary implementations, the depicted configurations provide additional room on the transceiver substrate 115 to position various other components (not shown). For example, a manufacturer can use the unutilized portions of both the front and rear surfaces 115A and 115B, respectively, of the transceiver substrate 115 to position components such as a laser driver, status indicator components such as LEDs, memory components, and components for driving bias currents or for amplifying signals.

FIG. 1C illustrates an exemplary arrangement where an optical transceiver module 100 is positioned on the HBA 200. As discussed in further detail below, such an arrangement is suitable for implementation in various types of computerized systems. As indicated in FIG. 1C, the optical transceiver module 100 includes, or is otherwise configured to be used in connection with, a face plate 124 so that the optical transceiver module is suitably configured for installation in, for example, a peripheral component interconnect (“PCI”) card for use in a desktop computer system. In some alternative embodiments, the face plate 124 comprises a smaller physical interface, such as a personal computer memory card international association (“PCMCIA”) envelope, which may be more appropriate for positioning the assembly within a smaller computerized system such as a laptop computer.

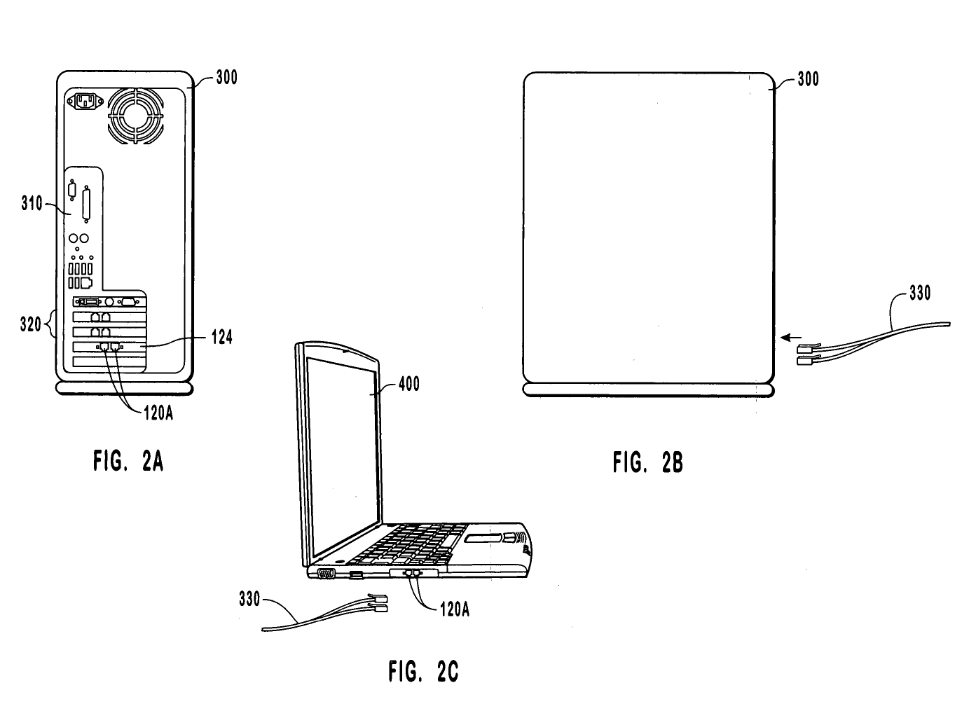

With reference now to FIGS. 2A through 2C, details are provided concerning some exemplary operating environments for embodiments of the optical transceiver module 100. In particular, FIG. 2A shows a computer system 300 having a component connection interface 310 that includes connection interfaces for a monitor, a a keyboard, and other peripheral devices. The computer system 300 also includes one or more physical device or network communication interfaces 320 that allow remote devices or network communications to be connected within the computer system 300 through such means as, for example, a PCI slot connection. Physical device or network communication interfaces 320 generally include, for example, Ethernet cable ports, and telephone cable ports, but can also include such interfaces for universal serial bus (USB) or IEEE 1394 (Firewire) specification communication interfaces.

In implementations where the computer system 300 includes an HBA 200 and transceiver module 100, the face plate 124 is exposed, revealing communication ports for ROSA 110 and TOSA 105. In some implementations, the face plate 124 also includes, or enables the use of, other components such as status indicator components. As indicated in FIG. 2B, a user can connect optical cables 330 into computer system 300. FIG. 2C illustrates a configuration where the HBA 200 and face plate 124 are configured to be slidably positioned into a laptop 400, such as through a PCI or PCMCIA card slot. Again, fiber optic cable 330 can be readily plugged directly into the optical transceiver module 100 by way of the face plate 124.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An optical transceiver module comprising:
a transceiver housing including two sides, a top, a bottom, and front and rear faces, at least the front face having right and left sides;
a transceiver substrate disposed within the transceiver housing so that the transceiver substrate is oriented substantially perpendicularly with respect to the top and bottom of the transceiver housing;
a receive optical assembly that defines a longitudinal axis, the receive optical assembly being positioned so that the longitudinal axis of the receive optical assembly is substantially perpendicular to the transceiver substrate and the receive optical subassembly being disposed proximate the left side of the front face of the transceiver housing; and
a transmit optical assembly that defines a longitudinal axis, the transmit optical assembly being positioned so that the longitudinal axis of the transmit optical assembly is substantially perpendicular to the transceiver substrate, and the transmit optical subassembly being disposed proximate the right side of the front face.

2. The optical transceiver module as recited in claim 1, wherein the axes respectively defined by the transmit optical sub-assembly and the receive optical sub-assembly are positioned above an imaginary horizontal plane that bisects the transceiver module.

3. The optical transceiver module as recited in claim 1, further comprising at least one electrical connection positioned proximate a lower edge of the transceiver substrate and arranged to be received in a corresponding of a host bus adaptor.

4. The optical transceiver module as recited in claim 1, wherein the host bus adaptor comprises one of: a PCI card; and a PCMCIA card.

5. The optical transceiver module as recited in claim 1, further comprising at least one electronic component positioned on one of a front or rear surface of the transceiver substrate.

6. The optical transceiver module as recited in claim 5, wherein the at least one electronic component includes at least one of: a laser driver; a signal amplifier; a status indicator component; a thermo-electric cooler; a current bias regulator; a capacitor; and, a resistor.

7. An optical transceiver module comprising:
a transceiver substrate, the transceiver substrate having a front surface and a rear surface and a top edge and bottom edge;
an electrical connector positioned proximate the bottom edge of the transceiver substrate;
a receive optical assembly positioned proximate the top edge of the transceiver substrate; and
a transmit optical sub-assembly positioned proximate the top edge of the transceiver substrate.

8. The optical transceiver module as recited in claim 7, further comprising a transceiver housing in which the transceiver substrate, receive optical assembly, and transmit optical assembly are positioned.

9. The optical transceiver module as recited in claim 8, wherein the transceiver housing defines at least one optical port slot located proximate the bottom edge of the transceiver substrate.

10. The optical transceiver module as recited in claim 7, wherein the optical transceiver module is configured to be positioned on a host bus adaptor.

11. The optical transceiver module as recited in claim 10, wherein the host bus adaptor comprises one of: a PCI; and, a PCMCIA card.

12. The optical transceiver module as recited in claim 7, wherein at least one of the following is positioned on at least one of the front surface and the rear surface of the transceiver substrate: a laser driver; a signal amplifier; a status indicator component; a thermo-electric cooler; a current bias regulator; a capacitor; and a resistor.

13. A host bus adaptor comprising;
a printed circuit board having at least one connector configured to electrically interface with a computer system; and
an optical transceiver module positioned on the printed circuit board, the optical transceiver comprising:
a transceiver substrate including electronic circuitry, the transceiver substrate having a front surface and a rear surface and top and bottom edges;
an electrical connector positioned proximate the bottom edge of the transceiver substrate;
a receive optical sub-assembly positioned proximate the top edge of the transceiver substrate; and
a transmit optical sub-assembly positioned to the right of the receive optical sub-assembly and proximate the top edge of the transceiver substrate, and the transmit optical sub-assembly and receive optical sub-assembly being in electrical communication with the electronic circuitry of the transceiver substrate.

14. The host bus adaptor as recited in claim 13, wherein at least one of the following is positioned on at least one of the front surface and the rear surface of the transceiver substrate: a laser driver; a signal amplifier; a status indicator component; a thermoelectric cooler; a current bias regulator; a capacitor; and a resistor.

15. The host bus adaptor as recited in claim 13, further comprising a transceiver housing in which the transceiver substrate, receive optical sub-assembly, and transmit optical sub-assembly are positioned.

16. The host bus adaptor as recited in claim 15, wherein the transceiver housing defines at least one optical port slot located proximate the bottom edge of the transceiver substrate.
